(19) United States
(12) Patent Application Publication
(10) Pub. No.: US 2005/0280307 A1
(43) Pub. Date: Dec. 22, 2005

(54) Plastic insert for ATV wheel rims

(76) Inventor: Bruce Wood, Oregon City, OR (US)

Correspondence Address: LITMAN LAW OFFICES, LTD, PO BOX 15035, CRYSTAL CITY STATION, ARLINGTON, VA, 22215, US

(21) Appl. No.: 10/872,516

(22) Filed: Jun. 22, 2004

(51) Int. Cl. B60C 25/132

(52) U.S. Cl. 301/37.35

(57) ABSTRACT

A plastic insert for all terrain vehicle (ATV) wheel rims. The plastic insert is preferably configured as an exact fit for a particular ATV wheel rim. The plastic insert has a plurality of lug nut holes defined therein that are configured to receive lug nuts to secure the plastic insert to the particular ATV wheel rim. The plastic insert provides protection of the ATV wheel rim from damaging effects of sand and rocks, as well as the ability to customize an associated ATV and/or to beautify old beat up ATV wheel rims of the associated ATV. The plastic insert may have one or more light emitting diodes (LEDs) mounted therein, that may be configured to emit a color(s), and may also have a removable power source mounted therein operationally connected to the LED(S). The removable power source may be a rechargeable battery and/or a non-rechargeable battery.

### BACKGROUND OF THE INVENTION

1. Field of the Invention

The present invention relates to wheel covers and, more particularly to a plastic insert for all terrain vehicle (ATV) wheel rims that provides easy protection of the ATV wheel rims from the damaging effects of sand, rocks, etc., as well as the ability to customize ATVs and/or to beautify old beat up ATV wheel rims.

2. Description of the Related Art

The popularity of ATVs has increased markedly over the past several years and has resulted in ATV use for a number of leisure and work related activities. ATVs provide great mobility and traction and, because of their relatively small size, are widely used on a variety of surfaces, such as sand dunes, back roads, mountain trails, dirt paths, etc. Because ATVs are also fairly powerful, they are also used to pull and push objects, such as trailers, snow plows, etc. During such activities, ATV wheel rims are bombarded with sand, rocks, dirt, mud, etc., resulting in detrimental effects occurring to the ATV wheel rims.

Wheel covers for motorized personal street vehicles, such as cars, trucks, etc., have been know for many years, primarily for decoration purposes. However, the inventor is not aware of any products that would allow for quick, easy protection of ATV wheel rims from the damaging effects of sand, rocks, dirt, mud, etc. Therefore, a need exists for a plastic insert for ATV wheel rims that can provide easy protection of the ATV wheel rims from the damaging effects of sand, rocks, etc., as well as the ability to customize ATVs and to beautify old beat up ATV wheel rims.

The related art is represented by the following references of interest.

U.S. patent application Publication No. US 2004/0041460 A1, published Mar. 4, 2004, describes a mud cover for attachment to the inside rear wheel of a vehicle to prevent track material from adhering to the wheel rim and thereby cause the wheel to become unbalanced. U.S. Pat. No. 1,854,728, issued Apr. 19, 1932 to Frederick W. Baker, describes a disk wheel with spaced rings associated with the periphery of the disk, and attached to the disk at three symmetrically spaced points only, a rim, and supporting members connected to the rim and to the spaced rings in staggered relation to the connections between the rings and the disk. U.S. Pat. No. 2,432,531, issued December 1947 to George A. Lyon, describes a wheel cover assembly. U.S. Pat. No. 3,7474,984, issued Jul. 24, 1973 to Eugene W. Andrews, et al., describes a plastic wheel cover used for enclosing and decorating the central portion of a tire rim.

U.S. Pat. No. 4,094,550, issued Jun. 13, 1978 to Desmond J. Toal, describes a wheel trim ring assembly for a motor vehicle. U.S. Pat. No. 4,441,762, issued Apr. 10, 1984 to William J. Segal, describes a decorative wheel cover for an automotive wheel hub that allows for the arbitrary multiplication of decorative designs displayed by the wheel covering. U.S. Pat. No. 4,511,183, issued Apr. 16, 1985 to Martin A. Spiegel et al., describes a wheel assembly for a vehicle that has a metal decorative cover extending over the wheel center of a conventional steel wheel. U.S. Pat. No. 4,530,542, issued Jul. 23, 1985 to Martin A. Spiegel et al., describes a non-ferrous wheel cover with a chromed steel cover.

U.S. Pat. No. 4,593,953, issued Jun. 10, 1986 to Takeshi Baba et al., describes an apparatus for covering a disc wheel for a motor vehicle. U.S. Pat. No. 4,971,396, issued Nov. 20, 1990 to Thomas C. Morris, describes wheel hub cover apparatus. U.S. Pat. No. 5,100,206, issued Mar. 31, 1992 to Le Jan Feng, describes an automobile wheel cover that is able to display the tire pressure. U.S. Pat. No. 5,263,770, issued Nov. 23, 1993 to Robert B. Goudey, describes a combined wheel cover and mounting device intended for use on large vehicles with dual wheels. U.S. Pat. No. 5,458,401, issued Oct. 17, 1995 to Bjorn Baccman, describes a metal applique that is configured to conform to the shape of the outer-face of a stock vehicle wheel.

U.S. Pat. No. 5,542,750, issued Aug. 6, 1996 to David J. FitzGerald, describes a wheel cover assembly retainer ring. U.S. Pat. No. 5,645,324, issued Jul. 8, 1997 to James P. Wright et al., describes a wheel trim attachment system that attaches to a yoke having a pair of collars, substantially half-moon shaped, separated by a tab. U.S. Pat. No. 5,695,257, issued Dec. 9, 1997 to James P. Wright et al., describes a wheel trim attachment system that uses a continuous attachment ring having mounting brackets which are pivotally and/or slidably attached to it thereby allowing it to be adjustable for different configurations of wheels.

U.S. Pat. No. 5,931,543, issued Aug. 3, 1999 to John D. Smith, describes disc wheel covers for forming optical illusions such as clockwise and counter-clockwise rotating spiral patterns. U.S. Pat. No. 6,371,569 B1, issued Apr. 16, 2002 to Edward R. Dean, describes a dust cover for placement between a wheel and brake assembly for preventing dust from the brakes to fall upon the wheel rim. U.S. Pat. No. 6,464,303 B2, issued Oct. 15, 2002 to Ronnie Stembridge, describes a decorative safety attachment for tire rims that includes a circular plate dimensioned for positioning over the tire rim.

European Patent Application Publication No. EP 0 187 228 A2, published on Jul. 16, 1986, describes a decorative wheel trim for motor vehicles. Japan Patent Application Publication No. JP 11-278002, published on Oct. 12, 1999, describes an automobile wheel cover. Germany Patent Application Publication No. DE 199 56 581 A1, published May 31, 2001, describes a cover for light metal rims on wheels fitted to a vehicle for long transport that has a mounting support with a separate body to stabilize a support wall against radially inward deflection.

None of the above inventions and patents, taken either singly or in combination, is seen to describe the instant invention as claimed. Thus a plastic insert for ATV wheel rims solving the aforementioned problems is desired.

### SUMMARY OF THE INVENTION

The present invention is a plastic insert for ATV wheel rims. The plastic insert is preferably configured as an exact fit for a particular ATV wheel rim. The plastic insert has a plurality of lug nut holes defined therein that are configured to receive lug nuts to secure the plastic insert to the particular ATV wheel rim. The plastic insert provides protection of the ATV wheel rim from damaging effects of sand and rocks, as well as the ability to customize an associated ATV and/or to beautify old beat up ATV wheel rims of the associated ATV.

The plastic insert may have one or more light emitting diodes (LEDs) mounted therein, that may be configured to emit a color. The plastic insert may also have a removable power source mounted therein operationally connected to the at least one LED. Such a removable power source may be a rechargeable battery and/or a non-rechargeable battery.

The plastic insert is a thermally stable and weatherable polymer and is preferably clear and function primarily to protect the ATV wheel rim from damage. However, the plastic insert may also have any color. The plastic insert has excellent color retention and gloss retention, and is solvent resistance, and is made from cellulosic materials, thermoset resins, or thermoplastic resins.

The plastic insert may be made from polyproylene, polyethelene, polyvinyl fluoride, polyvinyl chloride, polyvinyl acetate, polyvinyl alcohol, polyvinyl butyral, polycarbonate, polyolefins, polymer acrylonitrile-butadiene styrene (ABS) resins, homo or copolymeric aliphatic olefins of functionalized olefin polymer, polyester, and/or blends thereof.

The plastic insert is configured for use with an ATV wheel rim, the ATV wheel rim being configured to be mounted with off road tires that have low operating pressures and minimal belt reinforcements, and being configured to be implemented on an ATV having an overall width of about fifty inches or less, and an unladen dry weight of about six hundred pounds or less.

Accordingly, it is a principal aspect of the invention to provide a plastic insert for ATV wheel rims, the plastic insert being configured as an exact fit for a particular ATV wheel rim. The plastic insert has a plurality of lug nut holes defined therein that are configured to receive lug nuts to secure the plastic insert to the particular ATV wheel rim. The plastic insert provides protection of the ATV wheel rim from damaging effects of sand and rocks.

It is another aspect of the invention to provide a plastic insert for an ATV wheel rim in combination with an ATV wheel rim, the ATV wheel rim being configured to be mounted with off road tires that have low operating pressures and minimal belt reinforcements, and being configured to be implemented on an ATV having an overall width of about fifty inches or less, and an unladen dry weight of about six hundred pounds or less.

It is an aspect of the invention to provide improved elements and arrangements thereof in a plastic insert for ATV wheel rims for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of an ATV where the ATV wheel rims are equipped with plastic inserts according to the present invention.

FIG. 2 is a front perspective view of one of the ATV wheel rims equipped with plastic inserts shown in FIG. 1.

FIG. 3 is an exploded view of the ATV wheel rim equipped with plastic inserts shown in FIG. 2.

Similar reference characters denote corresponding features consistently throughout the attached drawings.

### DETAILED DESCRIPTION OF THE PREFERRED EMBODIMENTS

The present invention is a plastic insert for ATV wheel rims. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

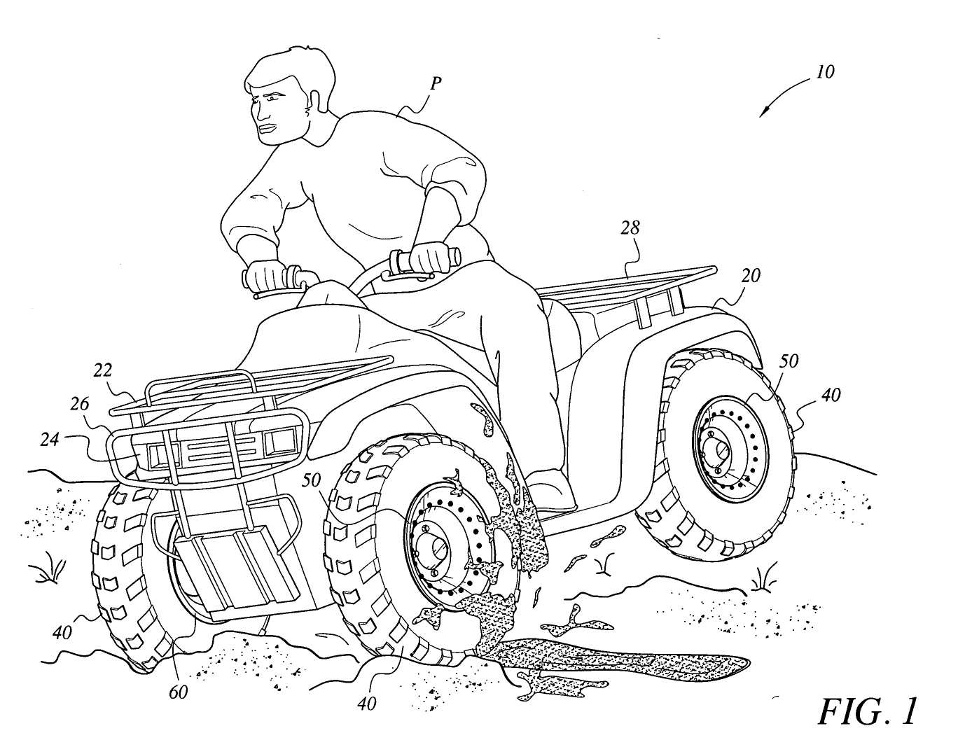

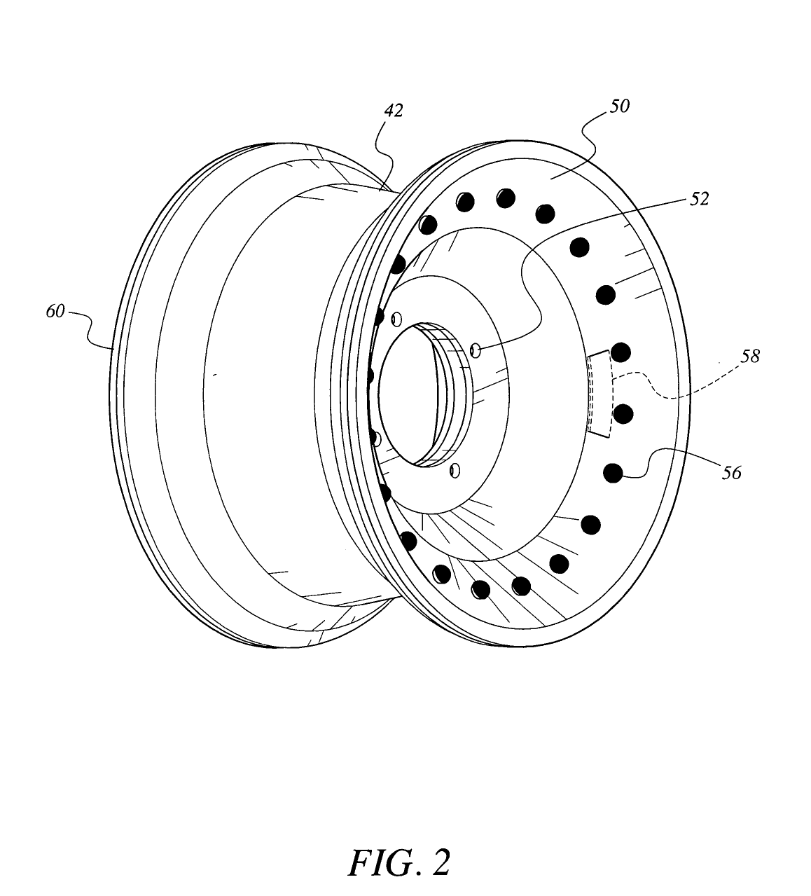

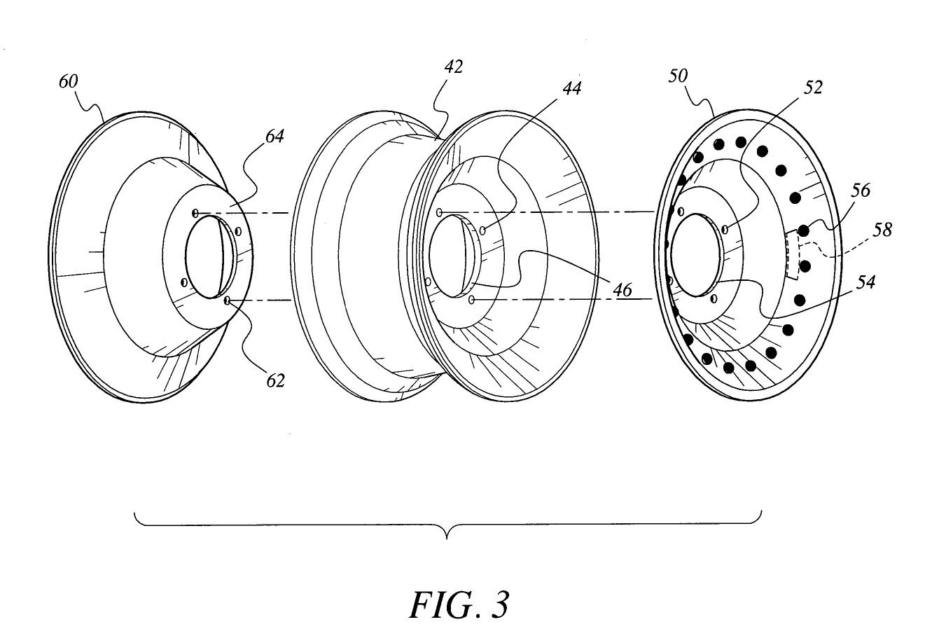

Referring to the drawings, FIG. 1 illustrates an individual P driving an ATV 10 in an off road condition. The ATV 10 is equipped with ATV tires 40 mounted on ATV wheel rims 42 (see FIGS. 2 and 3). Plastic inserts 50 and 60 are mounted on the ATV wheel rims 42. The plastic inserts, 50 and 60 provide easy protection of the ATV wheel rims from the damaging effects of sand, rocks, etc., as well as the ability to customize the ATV 10 and/or to beautify old beat up ATV wheel rims of the ATV 10.

The ATV tires 40 are pneumatic tires, are very wide with relatively large air chambers, and are configured to absorb shock and vibration. Preferably, the tires 40 have nominal rim diameters of fourteen inches or less, overall diameters of twenty-seven inches or less, are preferably configured to operate at generally less than ten pounds per square inch, and have no belt reinforcements.

The ATV 10 includes a frame 20 and the front tires 40 are steerable. A fuel tank and a seat are disposed on an upper portion of the frame 20. The engine is one of the heaviest components of the ATV 10 and is mounted in a central portion of the ATV 10 below the fuel tank and a front portion of the seat. The engine location of the ATV 10 may be chosen to ensure a proper weight distribution. A radiator may be provided if the engine is water cooled.

The ATV frame 20 includes a front portion 24 with a bumper and lights and is configured to accommodate typical ATV components such as the steering linkage, front differential, upper and lower front suspension arms, etc. Mounting brackets 22, 26, and 28 are attached to the frame 20.

The plastic inserts 50 and 60 are preferably configured as exact fits of the ATV wheel rim 42 shown in FIGS. 2 and 3. While there is an insert 50 for the outside of the ATV wheel rim 42 and an insert 60 for the inside of the ATV wheel rim 42, the implementation of either one is dependent on the desires of the user. The plastic inserts 50 and 60 are envisaged for use with wheel rims configured for use with typical ATVs, as represented by ATV wheel rim 42.

As used herein an ATV is relatively lightweight with a low center of gravity and is any motorized off-highway vehicle having an overall width of about fifty inches or less, an unladen dry weight of about six hundred pounds or less, is designed to travel on four or more low pressure tires, has a seat designed to be straddled by the operator and handlebars for steering control, and intended for use by a single operator and no passenger. Width and weight are exclusive of accessories and optional equipment.

The inserts 50 and 60 are made of plastic and are preferably made from thermally stable and weatherable polymers characterized by excellent color retention and gloss retention, solvent resistance, etc. Suitable material includes cellulosic materials, thermoset resins, thermoplastic resins, etc., such as polyproylene, polyethelene, polyvinyl fluoride, polyvinyl chloride, polyvinyl acetate, polyvinyl alcohol, polyvinyl butyral, polycarbonate, polyolefins, polymer acrylonitrile-butadiene styrene (ABS) resins, homo or copolymeric aliphatic olefins of functionalized olefin polymer, polyester, and/or blends thereof. The plastic inserts may be formed by any suitable manufacturing practice including thermoforming, high-pressure forming, hydroforming, die forming, etc.

The plastic inserts 50 and 60 are also preferably clear (e.g., transparent or translucent) and function primarily to protect the wheel rim 42 from damage. However, the plastic inserts may also be opaque and be provided with any color or combination of colors, such as camouflage, blue, green, red, orange, violet, purple, yellow, etc., according to the desires of the user for personally characterizing and/or decorating the ATV 10 in a particular manner.

The plastic inserts 50 and 60 have one or more lug nut holes 52 defined therein configured to receive lug nuts (not shown) to secure the plastic inserts 50 and 60 to the ATV wheel rims 42. The plastic inserts 50 and 60 may also have one or more light emitting diodes (LEDs) 56 mounted therein as well as a removable power source 58, such as a rechargeable and/or non-rechargeable battery. The LEDs 56 may be provided to illuminate in any color or combination of colors, such as blue, green, red, orange, violet, purple, yellow, etc.

ATVs as used herein include general use ATVs intended for general recreational and utility use, sport model ATVs intended for recreational use by experienced operators only, utility model ATVs intended primarily for utility use, and youth model ATVs intended for recreational off road use under adult supervision by operators under the age of sixteen. Youth model ATVs further include youth models intended for use by children age six and older youth models intended for use by children age twelve and older. Typical ATV manufacturers include Honda, Polaris, Yamaha, Suzuki, Kawasaki, Bombardier, Unilli, Barossa, SMC, Aeon, etc.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A plastic insert for ATV wheel rims, the plastic insert being configured as an exact fit for a particular ATV wheel rim, wherein said plastic insert has a plurality of lug nut holes defined therein configured to receive lug nuts to secure the plastic insert to the particular ATV wheel rim, and wherein said plastic insert provides protection of the ATV wheel rim from damaging effects of sand and rocks.

2. The plastic insert for ATV wheel rims according to claim 1, wherein said plastic insert has at least one light emitting diode (LED) mounted therein.

3. The plastic insert for ATV wheel rims according to claim 2, wherein said at least one LED is configured to emit a color or a combination of colors.

4. The plastic insert for ATV wheel rims according to claim 2, wherein said plastic insert has a removable power source mounted therein operationally connected to the at least one LED.

5. The plastic insert for ATV wheel rims according to claim 4, wherein said removable power source is a rechargeable battery.

6. The plastic insert for ATV wheel rims according to claim 4, wherein said removable power source is a non-rechargeable battery.

7. The plastic insert for ATV wheel rims according to claim 1, wherein said plastic insert is a thermally stable and weatherable polymer.

8. The plastic insert for ATV wheel rims according to claim 7, wherein said plastic insert is clear and functions primarily to protect the ATV wheel rim from damage.

9. The plastic insert for ATV wheel rims according to claim 7, wherein said plastic insert is opaque and has a color or a combination of colors.

10. The plastic insert for ATV wheel rims according to claim 7, wherein said plastic insert has excellent color retention and gloss retention, and is solvent resistance.

11. The plastic insert for ATV wheel rims according to claim 7, wherein said plastic insert is made from cellulosic materials, thermoset resins, or thermoplastic resins.

12. The plastic insert for ATV wheel rims according to claim 7, wherein said plastic insert is made from polyproylene, polyethelene, polyvinyl fluoride, polyvinyl chloride, polyvinyl acetate, polyvinyl alcohol, polyvinyl butyral, polycarbonate, polyolefins, polymer acrylonitrile-butadiene styrene (ABS) resins, homo or copolymeric aliphatic olefins of functionalized olefin polymer, polyester, or blends thereof.

13. The plastic insert for ATV wheel rims according to claim 1, in combination with an ATV wheel rim, said ATV wheel rim being configured to be mounted with off road tires that have low operating pressures and minimal belt reinforcements, and being configured to be implemented on an ATV having an overall width of about fifty inches or less, and an unladen dry weight of about six hundred pounds or less.

14. The combination according to claim 13, wherein said plastic insert has at least one light emitting diode (LED) mounted therein.

15. The combination according to claim 14, wherein said at least one LED is configured to emit a color or a combination of colors.

16. The combination according to claim 13, wherein said plastic insert has a removable power source mounted therein operationally connected to said at least one LED.

17. The combination according to claim 13, wherein said plastic insert is a thermally stable and weatherable polymer.

18. The combination according to claim 17, wherein said plastic insert is clear and function primarily to protect the ATV wheel rim from damage.

19. The combination according to claim 17, wherein said plastic insert has a color or a combination of colors.

20. The combination according to claim 17, wherein said plastic insert is characterized by excellent color retention and gloss retention, and is solvent resistance.
